(19) United States
(12) Patent Application Publication
(10) Pub. No.: US 2013/0340838 A1
(43) Pub. Date: Dec. 26, 2013

(54) FACILITATING STREAMING FLUID USING ACOUSTIC WAVES

(71) Applicant: Abbas RASTEGAR, Schenectady, NY (US)

(72) Inventor: Abbas RASTEGAR, Schenectady, NY (US)

(73) Assignee: SEMATECH, INC., Albany, NY (US)

(21) Appl. No.: 13/531,652

(22) Filed: Jun. 25, 2012

(51) Int. Cl. F15D 1/02

(52) U.S. Cl. 137/13; 137/803

(57) ABSTRACT

Systems and methods are provided facilitating a steaming fluid flow utilizing acoustic waves. A system includes an acoustic wave generator and an acoustic coupler associated with the acoustic wave generator and coupling acoustic waves generated by the acoustic wave generator into a fluid. The acoustic coupler includes one or more acoustic coupling lenses, which direct the acoustic waves into the fluid and facilitate, at least in part, a streaming fluid flow in a common direction. In an enhanced embodiment, the common flow direction is at an angle to a direction acoustic waves are generated, and the acoustic coupling lens(es), in directing the acoustic waves into the fluid, redirects the acoustic waves from the direction of acoustic wave generation. The acoustic wave generator generates the acoustic waves in the megahertz or gigahertz range, for example, with a frequency of 20 MHz or higher.

### BACKGROUND

Current semiconductor technology uses reflective optics, which require a surface roughness of, for example, approximately 1.5 angstrom RMS. As understood in the art, incident light is scattered by rough surfaces, which can lead to the loss of intensity of the reflected light and to image deformation.

Removal of particles, such as sub-100 nanometer (nm) particles, from a surface can be a challenging subject in semiconductor fabrication processing. Surface-particle interactions depend on the material and the surface structure, and generally are size independent. To remove a particle from a surface, adhesive forces between the particle and the surface need to be broken, and the particle needs to be transported far enough away from the surface so that the particle will not be redeposited on the surface.

Conventional wet-cleaning techniques that use under-etching of particles to remove particles from the surface result in undesirable roughening the surface, and thus, are no longer acceptable for today's semiconductor fabrication processes. Other examples for removing particles from a surface include transferring of energy to a particle, where the energy transfer efficiency to the particle on a surface strongly depends on the size of the particle on the surface. However, this method is best used to remove “soft” defects, such as particles that adhere to a surface due to van der Waals and electrostatic forces. Other particles that are chemically bonded to a surface are more difficult to remove. These particles are referred to as “hard” defects.

By way of example, energy can be transferred to particles on a surface by flowing a cleaning fluid over the surface. Unfortunately, close to the surface, there is a hydrodynamic boundary layer, which is a region immediately adjacent to the surface, with little or no flow. This boundary layer may have a thickness of a micron or more, while the particle to be removed may be a nanometer-scaled particle, making it difficult to remove such particles from the surface using a conventional cleaning fluid flow approach.

### BRIEF SUMMARY

The present invention relates, in one aspect, to a system which includes an acoustic wave generator and at least one acoustic coupler. The acoustic wave generator generates acoustic waves, and the at least one acoustic coupler is associated with the acoustic wave generator and couples the acoustic waves generated by the acoustic wave generator into a fluid. The at least one acoustic coupler includes at least one acoustic coupling lens directing the acoustic waves into the fluid and facilitating, at least in part, a streaming flow of the fluid in a common direction.

In another aspect, a system is provided which includes an acoustic wave generator, and at least one acoustic coupler associated with the acoustic wave generator. The acoustic wave generator generates acoustic waves, and the at least one acoustic coupler couples the acoustic waves generated by the acoustic wave generator into a fluid. The at least one acoustic coupler includes a plurality of acoustic coupling lenses directing the acoustic waves into the fluid and facilitating, at least in part, a streaming flow of the fluid in a common direction. The common fluid direction of the streaming flow is at an angle to a direction acoustic waves are generated by the acoustic wave generator, and the plurality of acoustic coupling lenses, in directing the acoustic waves into the fluid, redirect the acoustic waves from the direction of acoustic wave generation.

In a further aspect, a method is provided which includes: providing an acoustic wave generator, the acoustic wave generator generating acoustic waves; and providing at least one acoustic coupler associated with the acoustic wave generator, and coupling the acoustic waves generated by the acoustic wave generator into a fluid, the at least one acoustic coupler comprising at least one acoustic coupling lens directing the acoustic waves into the fluid and facilitating, at least in part, a streaming flow of the fluid in a common direction.

Additional features and advantages are realized through the techniques of the present invention. Other embodiments and aspects of the invention are described in detail herein and are considered a part of the claimed invention.

### BRIEF DESCRIPTION OF THE SEVERAL VIEWS OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1A is a schematic diagram of one embodiment of an acoustic wave system, in accordance with one or more aspects of the present invention;

FIG. 1B is a schematic diagram of a further embodiment of an acoustic wave system, in accordance with one or more aspects of the present invention;

FIG. 1C is a schematic diagram of a another embodiment of an acoustic wave system, in accordance with one or more aspects of the present invention;

FIG. 2 is a graph illustrating change in acoustic boundary layer thickness with change in frequency of acoustic waves generated, and change in fluid streaming velocity with change in acoustic wave frequency, in accordance with one or more aspects of the present invention;

FIG. 3A is a schematic of one embodiment of an acoustic wave system comprising a nozzle structure, in accordance with one or more aspects of the present invention;

FIG. 3B is a schematic, cross-sectional elevational view of one embodiment of the nozzle structure for the acoustic wave system of FIG. 3A, in accordance with one or more aspects of the present invention;

FIG. 3C is a schematic of an alternate nozzle structure embodiment, in accordance with one or more aspects of the present invention;

FIG. 3D is a schematic of another nozzle structure embodiment, in accordance with one or more aspects of the present invention;

FIG. 4 is a schematic diagram of another embodiment of an acoustic wave system, which comprises an acoustic nozzle structure and a flow coupler, in accordance with one or more aspects of the present invention;

FIG. 5A is a schematic diagram of another embodiment of an acoustic wave system, which employs multiple acoustic nozzle structures, in accordance with one or more aspects of the present invention;

FIG. 5B is a schematic diagram of a further embodiment of a acoustic wave system, which comprises multiple acoustic wave generators and acoustic couplers, in accordance with one or more aspects of the present invention;

FIG. 6A is a schematic diagram of another embodiment of an acoustic wave system configured for cleaning a target surface, in accordance with one or more aspects of the present invention;

FIG. 6B is a schematic diagram of a further embodiment of an acoustic wave system configured for cleaning a target surface, in accordance with one or more aspects of the present invention;

FIG. 7 is a schematic diagram illustrating an embodiment of an acoustic wave system configured as an acoustic fluid pump, in accordance with one or more aspects of the present invention; and

FIG. 8 depicts one embodiment of a process for acoustically facilitating a streaming fluid flow, in accordance with one or more aspects of the present invention.

### DETAILED DESCRIPTION

The invention and various features, advantageous and details thereof are explained more fully below with reference to the non-limiting embodiments illustrated in the accompanying drawings. Descriptions of well-known starting materials, processing techniques, components, and equipment, are omitted so as not to unnecessarily obscure the invention in detail. It should be understood, however, that the detailed description and the specific examples, while indicating embodiments of the invention, are given by way of illustration only, and are not by way of limitation. Various substitutions, modifications, additions, and/or rearrangements within the spirit and/or scope of the underlying inventive concepts will be apparent to those skilled in the art from this disclosure.

As noted, disclosed herein are certain novel acoustic wave systems and methods for facilitating a streaming flow of fluid. Generally stated, the acoustic wave systems disclosed herein include one or more acoustic wave generators and one or more acoustic couplers. An acoustic wave generator generates acoustic waves, and an acoustic coupler is associated with the acoustic wave generator and includes one or more acoustic coupling lenses which couple the acoustic waves generated by the acoustic wave generator into a fluid. The acoustic coupling lens(es) is configured to direct the acoustic waves into the fluid to facilitate a streaming flow of the fluid in a common direction.

As noted initially, particle removal can be a main defectivity issue for today's semiconductor processes, such as for sub-22 nm technology nodes for patterned extreme ultraviolet radiation (EUV) masks, wafers, and nano-imprint templates. Creating fast flows close to a target surface can be a challenge due to the interaction of the surface and liquid(s) and the creation of a boundary layer along the surface. Different methods can be used to generate high-speed flows closer to a target surface, such as captivation collapse. Disclosed herein is an alternate approach to reducing boundary layer thickness by generating a controllable, high-speed fluid flow close to the target surface to, for example, facilitate particle removal for, for example, enhanced patterned EUV masks, wafers, and nano-imprint templates.

Reference is made below to the drawings (which are not drawn to scale to facilitate understanding of the invention), wherein the same or similar reference numbers used throughout different figures designate the same or similar components.

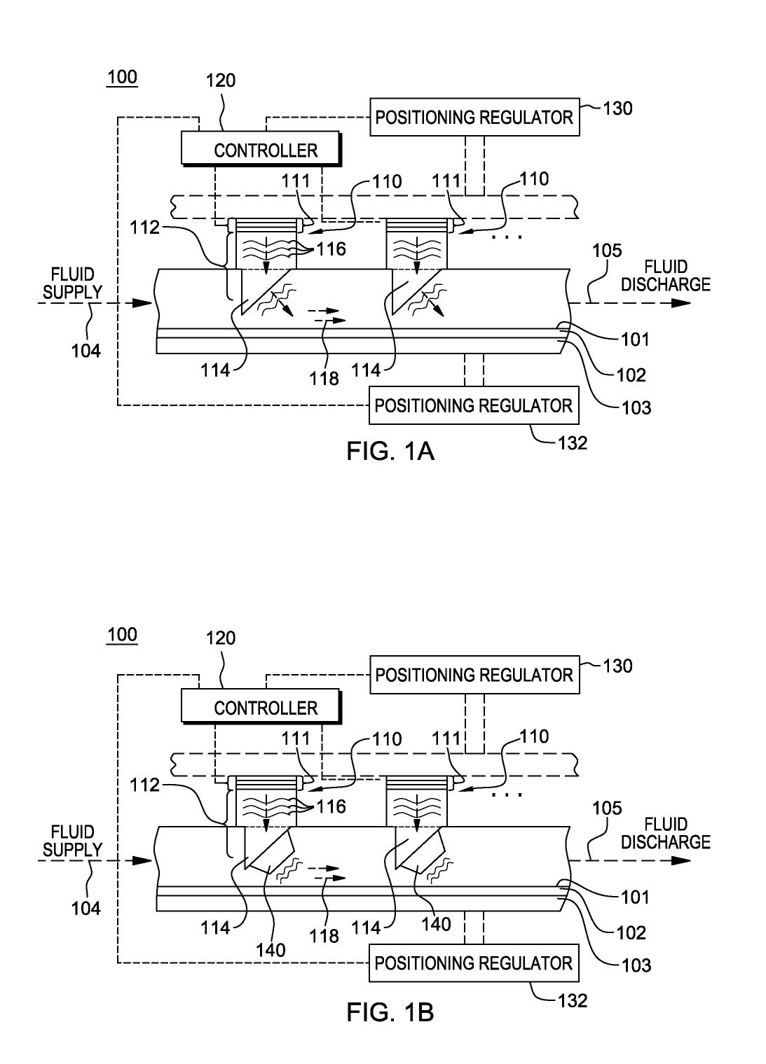

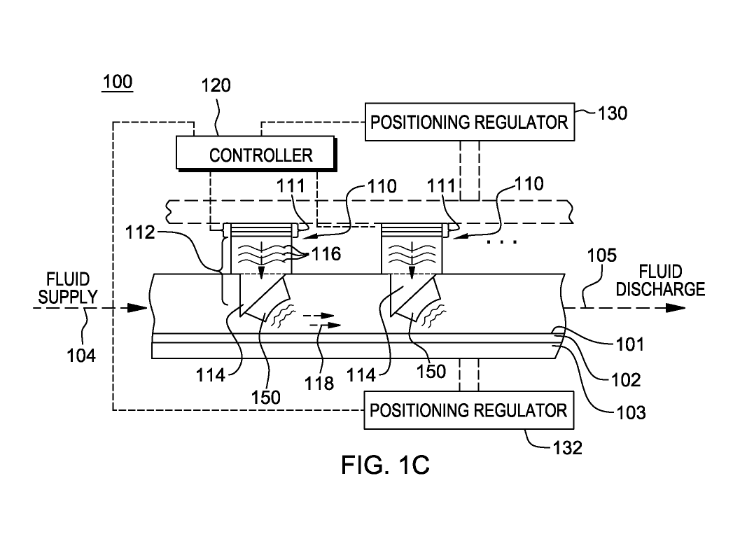

FIG. 1A depicts one embodiment of an acoustic wave system, generally denoted 100, which facilitates, at least in part, a streaming flow of fluid in a common direction, in accordance with one or more aspects of the present invention. The system may include an array of acoustic transducers 110, each of which converts electrical energy into acoustic waves and includes, in one example, an acoustic wave generator 111, and an acoustic coupler 112. As illustrated, acoustic couplers 112 each comprise an acoustic coupling lens 114 in this implementation.

The resonant frequency of an acoustic transducer 110 is inversely proportional to the size of the acoustic transducer, and the sizes and the materials of the acoustic transducers are selected to facilitate generation and emission of acoustic waves 116, for example, with a frequency of 20 MHz or higher, such as 100 MHz or higher, or even 1 gigahertz (GHz) or higher. In accordance with an aspect of the present invention, acoustic waves 116 are redirected by the acoustic coupling lenses 114 to facilitate, at least in part, a streaming fluid flow 118 in a common direction, for example, parallel to a target surface 101. Very high-frequency piezoelectric transducers (MHz to GHz) may be employed as the acoustic wave generators 111 to generate very high-frequency acoustic waves 116.

Target surface 101 comprises, in one example, a surface of a structure 102, such as a wafer, mask, plate, etc., which is supported via a chuck 103 of a cleaning apparatus or station. Fluid 104 is provided, in one example, at a first edge of target surface 101 (e.g., from a supply manifold or reservoir (not shown)), and exhausted at a second, opposite edge as fluid discharge 105 (e.g., via a discharge manifold (not shown)). The array of acoustic transducers 110 operate (in one embodiment) to enhance the speed of the fluid flowing across the target surface via the provision of high-frequency, periodic acoustic waves into the fluid to generate the streaming fluid flow 118 in the common direction across the target surface. As noted, in practice, the generated acoustic waves may be greater than 100 MHz, or even greater than 1 GHz.

In one implementation, acoustic transducers 110 may be controlled to generate acoustic waves 116 at or around the resonant frequency of a particle on the target surface, directly exciting the particle, and causing the particle to dislodge from the target surface. In other embodiments, the acoustic wave system 100 may cause direct excitation alone to remove particles, or may cause direct excitation in conjunction with other mechanisms, such as captivation, for particle removal.

A controller 120 may activate and deactivate the array of acoustic transducers 110 by sending signals, or applying voltages to the transducers. In one embodiment, controller 120 may be coupled to a signal bus that is electrically connected to the acoustic transducers, and in particular, to the acoustic wave generators 111, which in one embodiment, may comprise piezoelectric transducers.

In the embodiment illustrated, a first positioning regulator 130 and a second positioning regulator 132 are provided to facilitate positioning of the array of acoustic transducers 110 relative to target surface 101. In one embodiment, controller 120 is coupled to position regulators 130, 132 for automatically adjusting the regulators to a desired spacing of the acoustic transducers relative to the target surface. By way of example, a substrate (not shown) may be employed, upon which the array of acoustic transducers 110 may be arrayed, and to which positioning regulator 130 may couple. Alternatively, positioning regulator 130 may couple directly to each acoustic transducer in the array of acoustic transducers, and thereby control positioning of the acoustic transducers individually relative to the target surface.

The array of acoustic transducers 110 are coupled to the target surface 101 through fluid 104. In certain embodiments, fluid 104 may be water, and the water may be de-ionized, distilled, or purified by other means. In other embodiments, fluid 104 may comprise a chemical solution.

In certain embodiments, the positioning regulators 130, 132 may be employed to position, for example, via the controller, the array of acoustic transducers 110 to within (for instance) 1 millimeter of target surface 101. In other embodiments, the positioning regulators may be employed to position the array of acoustic transducers at different distances from the target surface 101, depending upon the frequency or frequencies being emitted and rate at which the acoustic waves 114 dissipate in the fluid.

In one embodiment, one or more of controller 120 and/or positioning regulators 130/132 may include a machine or machines with executable instructions. For example, controller 120 and/or positioning regulators 130, 132 may include a hardware circuit comprising custom VLSI circuits or gate arrays, off-the-shelf semiconductors, such as logic chips, transistors, or other discrete components. Controller 120 and/or positioning regulators 130, 132 may also include programmable hardware devices such as processors, special purpose microprocessors, field-programmable gate arrays, programmable logic, programmable logic devices, or the like.

The controller 120 and/or positioning regulators 130, 132 may further include software modules, which may include software-defined units or instructions, that when executed by a processing machine or device, transform data stored on a data storage device from a first state to a second state. An identified module of executable code may, for instance, comprise one or more physical or logical blocks of computer instructions, which may be organized as an object, procedure, or function. Nevertheless, the executables of an identified module may not be physically located together, but may comprise disparate instructions stored in different locations which, when joined logically together, comprise the module, and when executed by the processor, achieve the stated transformation.

As noted, the acoustic transducers 110 each include, in addition to an acoustic wave generator 111, an acoustic coupler 112. The generated MHz or GHz acoustic waves 116 propagate through the acoustic couplers 112, which in one embodiment, may be fabricated of sapphire or quartz. One or more acoustic coupling lenses 114 are integrated as part of each acoustic coupler. The acoustic coupling lenses are at the end of each respective resonator, and direct the high-frequency acoustic waves 116 into fluid 104 (for example) in a common fluid direction to facilitate creating streaming fluid flow 118. The acoustic-powered, streaming flows are generated inside the fluid in the direction of wave propagation, as redirected by the acoustic coupling lenses 114. Advantageously, streaming flows in the GHz regime can be as fast as 1000 m/sec in the vicinity of target surface 101. Such streaming flows may be on top of any static flow of the fluid, such as a left-to-right flow of cleaning fluid across the target surface in the illustration of FIG. 1A. The acoustic coupling lenses may advantageously redirect and/or reshape the acoustic waves 116 to help generate fluid flow closer to target surface 101 to, for example, help reduce the boundary layer between the fluid and the target surface, and thereby facilitate removal of unwanted particles from the surface.

The acoustic coupling lenses, which in one example are integrated with and comprise the same material as the acoustic coupler, can be designed in various shapes and sizes, depending upon the desired implementation. In FIG. 1A, the acoustic coupling lenses 114 comprise angled acoustic coupling lenses, which facilitate redirecting the acoustic waves in the common direction of the streaming fluid flow 118. In this embodiment, the common fluid direction is parallel to target surface 101, and substantially perpendicular to a direction acoustic waves 116 are generated by acoustic wave generators 111. In one embodiment, the angled acoustic coupling lenses of the acoustic coupling system 100 of FIG. 1A are substantially identical. Alternatively, depending upon the implementation, one or more of the acoustic coupling lenses within the system may be designed with different shapes or sizes, depending (for instance) on the requirements of the acoustic wave system or operation to be performed. Furthermore, the number of acoustic transducers in the array may vary, depending on the application.

The acoustic wave systems illustrated in FIGS. 1B & 1C are substantially identical to acoustic wave system 100 of FIG. 1A, with the exception that different types of acoustic coupling lenses are employed as part of the acoustic couplers of the acoustic transducers in the acoustic wave systems illustrated. Depending on the application, different types of lenses, such as the lenses illustrated in FIGS. 1A-1C, may be selected and/or combined within a single array of acoustic transducers, if desired to assist with a unidirectional flow. In the acoustic coupling lens embodiments of FIGS. 1B & 1C, different focusing lens configurations are illustrated. Note that in the depicted examples, the focusing lenses 140, 150 are employed in combination with the angled lenses 114 (by way of example only). A variety of different lens types and shapes may be employed to facilitate the desired unidirectional, streaming fluid flow.

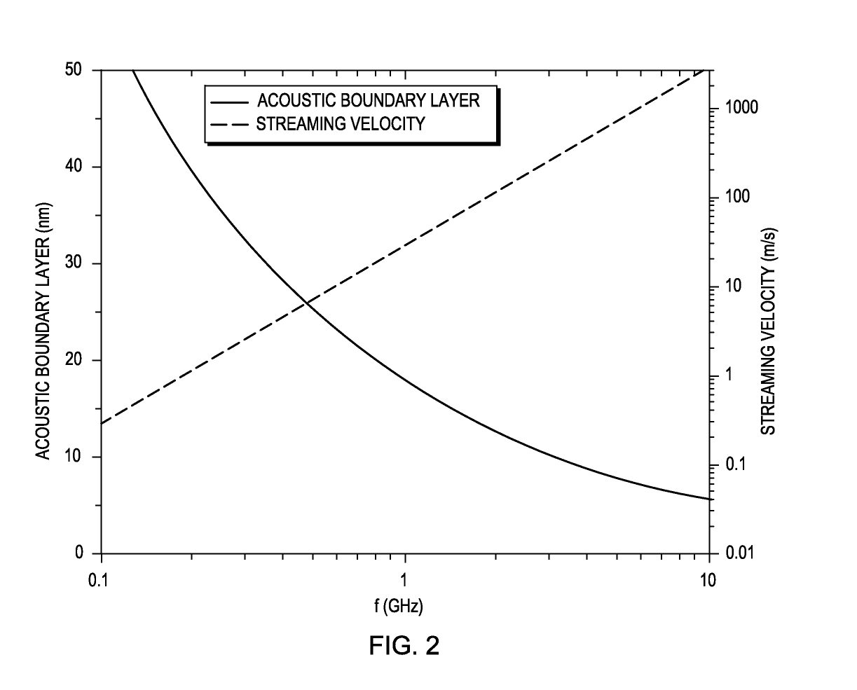

FIG. 2 graphically illustrates change in acoustic boundary layer thickness with change in frequency of acoustic waves generated by an acoustic wave system such as disclosed herein, and change in fluid streaming velocity with change in acoustic wave frequency. As illustrated in FIG. 2, acoustic streaming velocity can reach up to 1000 m/sec at frequency of 10 GHz in water. At the same time, the boundary layer thickness reduces to sub-10 nm, and therefore, very fast flows can be generated close to the target surface. These very fast flows close to the target surface advantageously can be employed, in one embodiment, to directly excite unwanted particles on the target surface and ensure the removal of particles from the target surface.

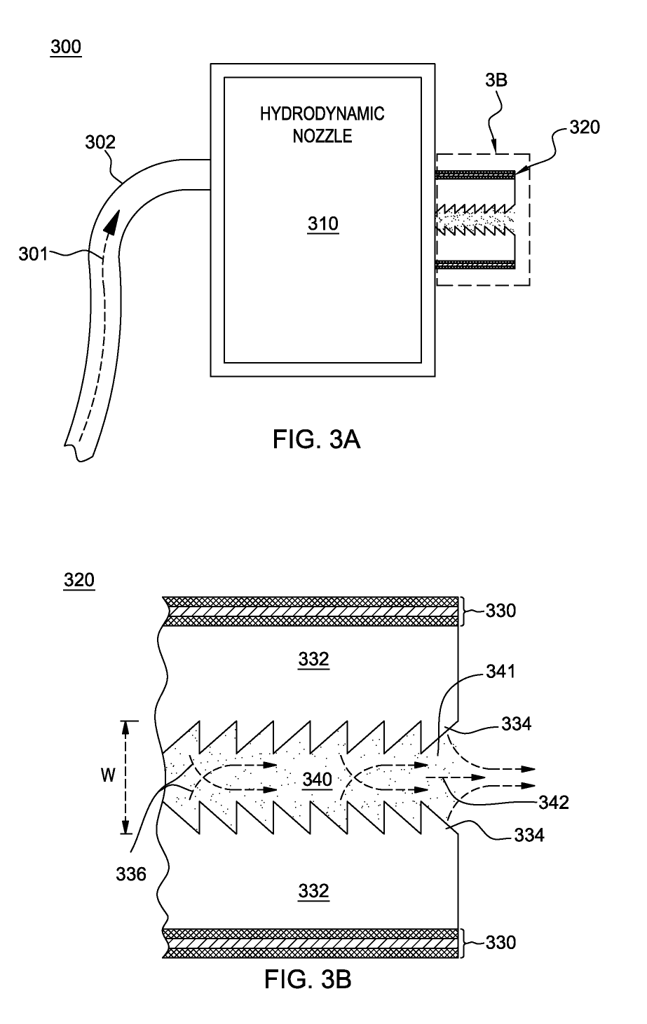

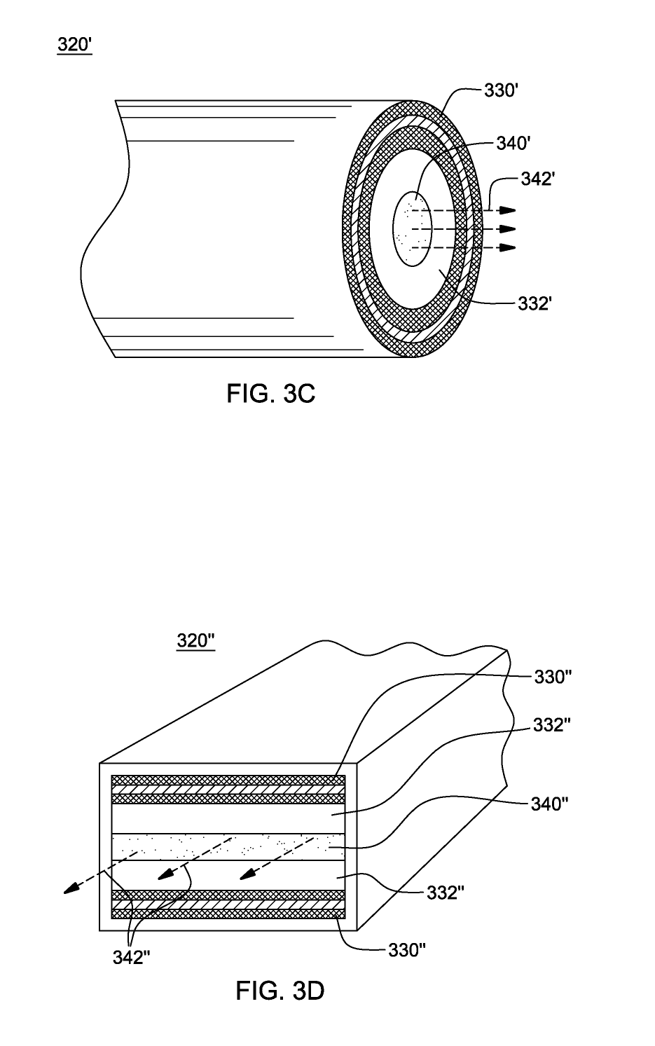

FIGS. 3A-3D depict an alternate embodiment of an acoustic wave system, generally denoted 300, in accordance with one or more aspects of the present invention. In this system, a fluid 301 is provided via a hose 302 to a hydrodynamic nozzle 310 and output via an acoustic nozzle structure 320. FIGS. 3B-3D illustrate possible embodiments of an acoustic nozzle structure 320, 320′, 320″, respectively, for (for instance) use with a system such as depicted in FIG. 3A. Note that as used herein, a hydrodynamic nozzle refers to a conventional fluid nozzle governed by hydrodynamic forces, as compared to acoustic-induced forces in an acoustic nozzle.

Referring to FIG. 3B, one embodiment of acoustic nozzle structure 320 is illustrated comprising an acoustic wave generator 330, such as a piezoelectric transducer, as well as an acoustic coupler 332 with a plurality of acoustic coupling lenses 334 at the end of the resonator which project into, for example, a channel (or micro-channel) 340 of the acoustic nozzle structure 320. As illustrated, channel 340 has a width ‘w’. By way of example, width ‘w’ may be between 10 μm and 1 mm, such as within a range of 500 μm to 1 mm. In the embodiment illustrated, both upper and lower acoustic transducers are employed, each with a plurality of acoustic coupling lenses 334 projecting into the channel, and angled so that, in operation, acoustic waves generated by the acoustic wave generators 330 propagate via the acoustic couplers 332, and the angled acoustic coupling lenses 334, as acoustic waves 336 into the fluid 341 within channel 340. As illustrated, these acoustic waves 336 establish a high-speed, streaming flow of fluid 342 in a common direction.

In FIG. 3C, the acoustic nozzle structure 320′ is reconfigured with a cylindrical-shaped geometry, wherein the acoustic wave generator 330′ also comprises a cylinder, as does the acoustic coupler 332′ with the plurality of acoustic coupling lenses projecting from an inner surface thereof into fluid channel 340′ so as to facilitate redirecting of acoustic waves into the fluid in a common fluid direction to establish a streaming fluid flow 342′.

In FIG. 3D, an acoustic nozzle structure 320″ is illustrated with a rectangular-shaped geometry. In this embodiment, upper and lower acoustic wave generators 330″ generate acoustic waves which propagate via upper and lower acoustic couplers 332″ into a fluid channel 340″. As in the embodiments discussed above, the acoustic couplers include a plurality of acoustic coupling lenses (not shown), which facilitate redirecting the generated acoustic waves into the fluid so as to create the streaming fluid flow 342″ in a common direction through the nozzle. In one embodiment, this common fluid direction is substantially perpendicular to a direction of acoustic wave generation by the acoustic wave generators. By appropriately sizing the fluid channel, for example, as a micro-sized channel, high-speed streaming flows can be generated.

Note that the acoustic coupling lenses employed in the acoustic nozzle structures such as depicted in FIGS. 3A-3D may be designed to prevent interference between the one or more acoustic wave sources. As noted, the acoustic nozzle structures disclosed herein may comprise, in one embodiment, a Gigasonic nozzle that can be mounted on top of a hydrodynamic nozzle, such as depicted in FIG. 3A.

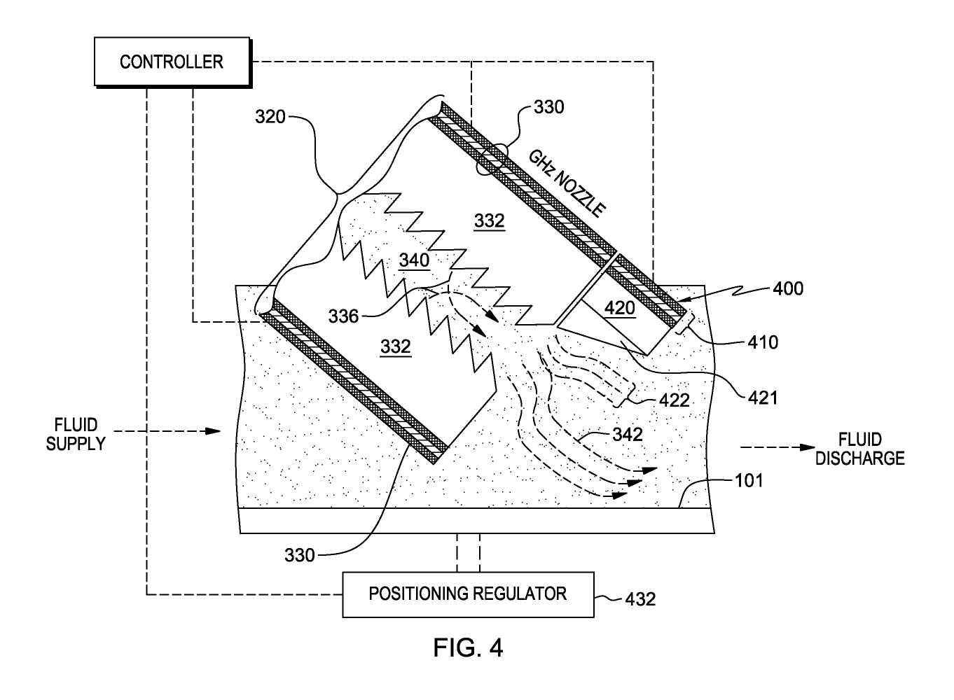

FIG. 4 depicts an alternate embodiment of an acoustic wave system, in accordance with one or more aspects of the present invention. In this embodiment, the acoustic wave system includes an acoustic nozzle structure 320, such as described above in connection with FIG. 3B, as well as a flow coupler 400, which is (in one embodiment) a high-frequency acoustic device designed to further reduce the hydrodynamic boundary layer close to target surface 101.

In particular, acoustic nozzle structure 320 includes one or more acoustic wave generators 330 and one or more acoustic couplers 332, each with a plurality of acoustic coupling lenses 334, positioned and angled, in the depicted embodiment, to facilitate redirecting of acoustic waves 336 into fluid within channel 340 of the nozzle structure in a common direction to establish a streaming flow of fluid 342. As illustrated, an outlet of the acoustic nozzle structure 320 is angled (in this embodiment) relative to target surface 101. Flow coupler 400 includes an acoustic wave generator 410 and an acoustic coupler 420, with an enlarged, angled acoustic coupling lens 421 that generates acoustic waves 422 that operate (in the depicted embodiment) to force the streaming fluid flow 342 at the outlet of the nozzle structure down, closer to target surface 101. In one example, flow coupler 400 may be fabricated of the same material and have similar construction to that of the acoustic transducers of the acoustic nozzle structure 320. In the depicted example, a single acoustic coupling lens 421 is illustrated, which is larger than the acoustic coupling lenses within the acoustic nozzle structure 320, and is presented by way of example only. In one or more alternate embodiments, the flow coupler 400 may comprise multiple acoustic coupling lenses directing acoustic waves 422 towards the streaming fluid flow 342 output from acoustic nozzle structure 320.

As with the embodiment of FIG. 1A, a controller 430 and one or more positioning regulators 432 may be provided. In one embodiment, controller 430 is electrically coupled to the acoustic wave generators 330, 410, to selectively control generation of acoustic waves within the system, as well as to positioning regulator 432 to, for example, control distance between the outlet of the acoustic nozzle structure 320 and target surface 101.

In the embodiment of FIG. 4, the interaction between the fluid and the target surface (that is, the boundary layer) is reduced in front of the acoustic nozzle structure, with high-speed fluid flows reaching closer to the target surface. The flow coupler may be a single flow coupler, or multiple flow couplers, and can be designed in different shapes and positioned in different locations to force the streaming fluid flow closer (for example) to the target surface.

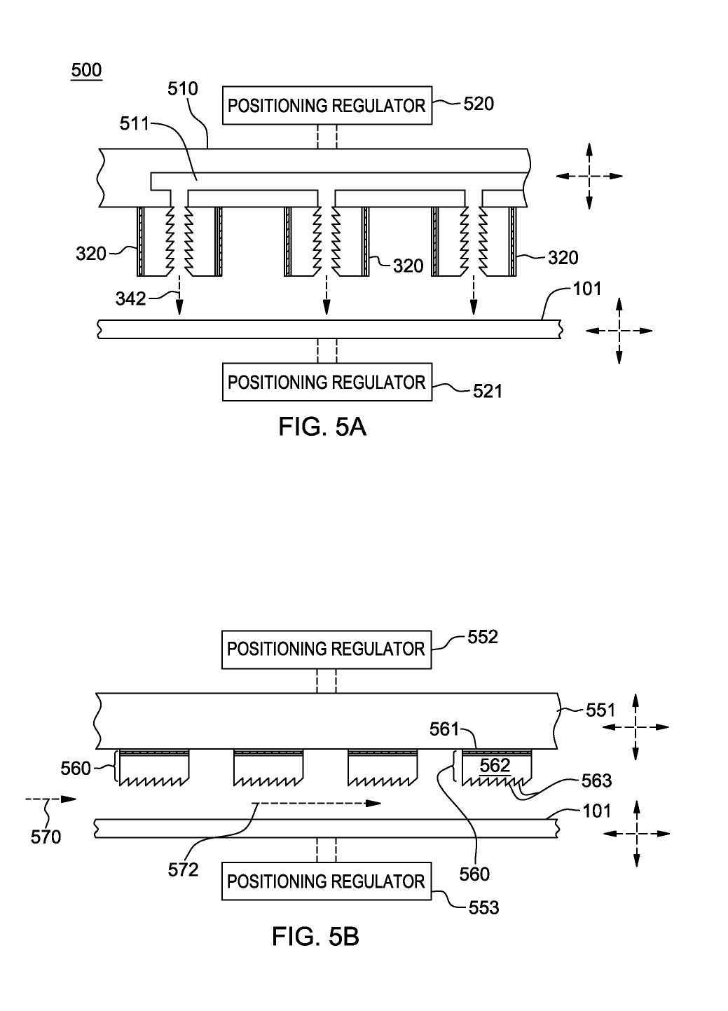

FIGS. 5A & 5B depict further alternate embodiments of acoustic wave systems 500, 550. These systems may be assembled employing, for example, micro-electromechanical systems (MEMS) or nano-electromechanical systems, and three-dimensional interconnect processes.

Referring to FIG. 5A, acoustic wave system 500 includes a plurality of acoustic nozzle structures 320, such as (by way of example) described above in connection with FIG. 3B. A fluid manifold 510 is provided with one or more fluid channels 511 that feed fluid to the respective acoustic nozzle structures 320 of the system. In one application, the nozzle structures may be positioned close to a target surface 101 to be cleaned via a first positioning regulator 520 and a second positioning regulator 521 of the acoustic wave system 500. Positioning regulators 520, 521 may be controlled via a controller (not shown), in a manner similar to that described above in connection with FIG. 1A, to position (and/or move) the acoustic nozzle structures 320 with respect to the target surface 101. In each instance, the acoustic nozzle structures 320 output a controllable streaming fluid flow in a common fluid direction, employing (for example) one or more acoustic wave generators and one or more acoustic couplers, each comprising a plurality of acoustic coupling lenses, such as the depicted angled acoustic coupling lenses described above.

In the embodiment of FIG. 5B, an acoustic wave system 550 is illustrated, wherein an array of acoustic transducers 560 are disposed on a common substrate 551 for, for example, a different application than the acoustic wave system of FIG. 5A. In this embodiment, the acoustic transducers 560 each include one or more acoustic wave generators 561, and one or more acoustic couplers 562, each with a plurality of acoustic coupling lenses 563. In this embodiment, and by way of example only, the acoustic coupling lenses comprise angled acoustic coupling lenses that facilitate a streaming flow of fluid. The array of acoustic transducers are shown disposed in close proximity to a target surface 101, with the distance to the target surface being controlled, for example, via one or more positioning regulators 552, 553, and a controller (not shown), in a manner similar to that described above in connection with FIG. 1A. In this embodiment, a fluid 570 is driven by the acoustic waves directed into the fluid into a high-speed streaming fluid flow 572. As with the embodiments described above, in both FIGS. 5A & 5B, the acoustic waves may be in the 20 MHz or higher range, such as the 100 MHz or higher range, or even the 1 GHz or higher range.

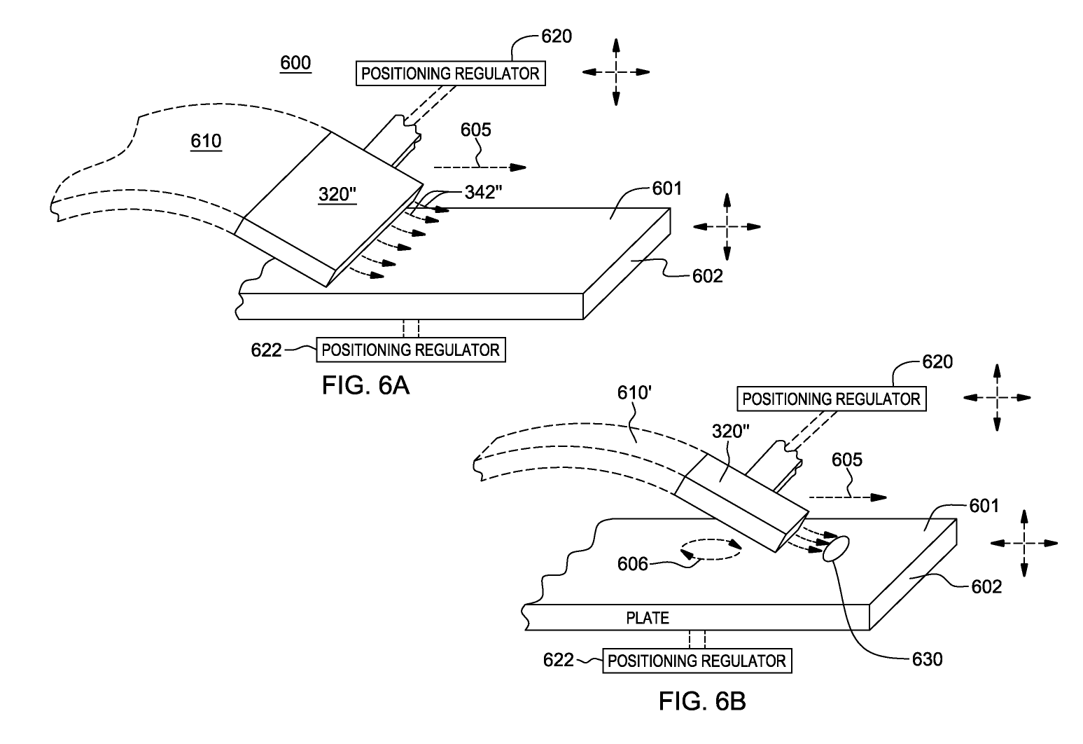

FIGS. 6A & 6B depict further alternate embodiments of acoustic wave systems 600, 600′, respectively, in accordance with one or more aspects of the present invention.

Referring to first FIG. 6A, acoustic wave system 600 is shown to comprise an acoustic nozzle structure 320″ configured, for example, such as described above in connection with FIG. 3D. As illustrated, the acoustic nozzle structure 320″ produces a streaming fluid flow 342″, which is used (in the illustrated embodiment) to clean a target surface 601 of a structure 602, such as a plate, wafer, mask, etc. Cleaning is facilitated by a linear scan 605 of the acoustic nozzle structure 320″ across the face of target surface 601. An appropriately configured hose or manifold 610 feeds fluid to the acoustic nozzle structure 320″ and positioning regulators 620, 622 and a controller (not shown) control the acoustic nozzle structure and facilitate controlled linear movement of the acoustic nozzle structure across the target surface. In one embodiment, the high-speed acoustic nozzle structure is thus coupled to a moveable, controllable arm, and produces a sheet of high-speed fluid flow 342″ across the face of target surface 601. Positioning regulators 620, 622 and the controller may be similar to the regulators and controller described above in connection with FIG. 1A. In one embodiment, the controller controls the linear scan via the positioning regulator 620 coupled to the acoustic nozzle structure, and moves the nozzle structure across the target surface. As noted above, the controller may also control generation of acoustic waves via the respective one or more acoustic wave generators within the nozzle structure.

FIG. 6B depicts an alternate embodiment of an acoustic wave system 600′ from that depicted in FIG. 6A. In this alternate embodiment, the acoustic nozzle structure 320″ is again positioned for linear scanning across target surface 601, but is sized smaller, for example, as a spot-sized nozzle, to direct the streaming fluid flow 342″ onto a smaller target area 630 of target surface 601. In addition, the arm controlled by positioning regulator 620 is further configured to rotate 606 so as to facilitate directing the streaming fluid flow onto the target surface in various different directions across the surface as needed to remove unwanted particles from the surface. Fluid is fed to acoustic nozzle structure 320″ via a hose, manifold, etc., 610′, and a high-speed, streaming fluid flow is output from the acoustic nozzle structure 320″.

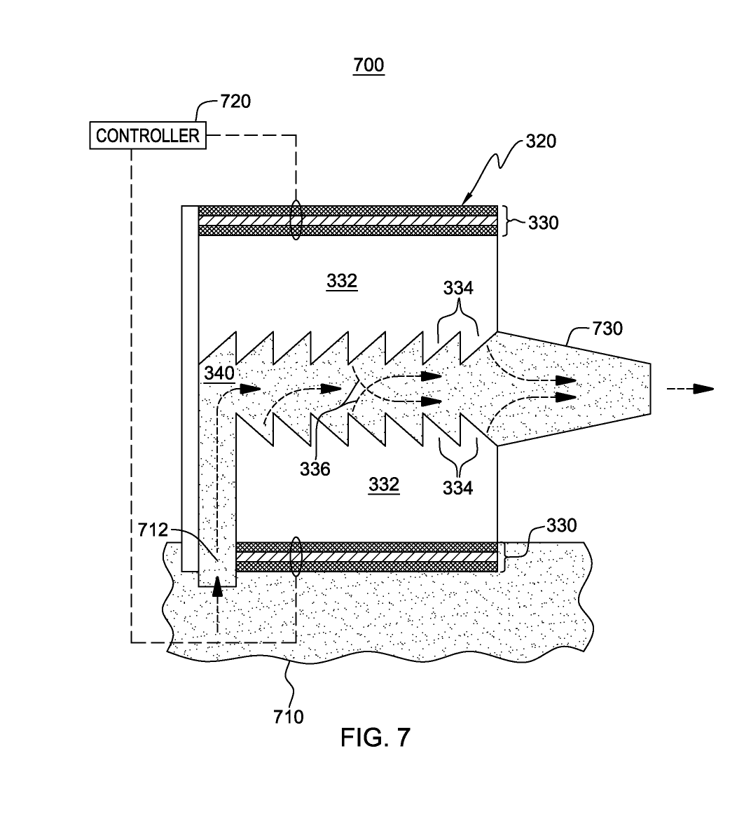

FIG. 7 depicts a further alternate embodiment of an acoustic wave system 700, in accordance with one or more aspects of the present invention. In this embodiment, the acoustic wave system is configured as a pump utilizing, by way of example only, the acoustic nozzle structure 320 illustrated in FIG. 3B. One modification to the nozzle structure is that a fluid channel 712 is provided into the nozzle, coupling in fluid communication a fluid reservoir 710 containing a fluid, such as water, and one or more channels 340 of the nozzle structure 320. The system further includes a controller 720, which (in one embodiment) controls acoustic wave generation via one or more acoustic wave generators 330. As described herein, generated acoustic waves propagate via the acoustic couplers 332 through a plurality of acoustic coupling lenses 334, where the waves are redirected into the fluid in channel(s) 340 to flow in a common direction. This results in a fluid pumping action and a flow through the system, with a streaming fluid flow 342 being output via an outlet nozzle 730. In one implementation, the plurality of acoustic coupling lenses are a plurality of angled acoustic coupling lenses, such as discussed above, and the acoustic wave generator(s) comprises a piezoelectric transducer(s). In the depicted implementation, one side of acoustic nozzle structure 320 is closed, with fluid channel 712 coupling channel 340 of the nozzle structure 320 in fluid communication with the fluid reservoir. Note that location and configuration of the respective channels, as well as the acoustic coupling lenses can vary, and depend upon the particular pump characteristics desired.

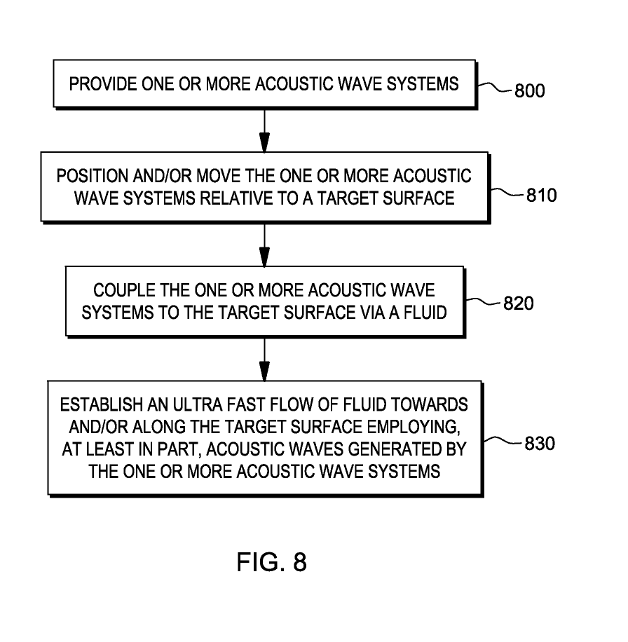

FIG. 8 depicts one embodiment of a process for facilitating, for example, cleaning of a target surface employing an acoustic wave system such as described above in connection with FIGS. 1A-7. The process begins by providing one or more acoustic wave systems 800, and positioning or moving the one or more acoustic wave systems adjacent to a target surface 810. The one or more acoustic wave systems are coupled to the target surface via a fluid, such as a cleaning fluid 820, and an ultra-fast flow of the fluid is established along (or towards, for example, via a nozzle structure) the target surface employing, at least in part, acoustic waves generated by the one or more acoustic wave systems 830 and redirected within the system(s) via one or more acoustic coupling lenses.

Advantageously, the acoustic wave systems and the acoustic nozzle structures disclosed herein can be employed, in one application, to generate very high-speed fluid flows close to a target surface in a controlled manner, which is a significant improvement to existing technologies. For instance, the acoustic wave systems disclosed herein can comprise or be integrated within cleaning tools to improve performance, and reduce resultant defectivities in masks, wafers, templates, etc., used in today's semiconductor fabrication.

As will be appreciated by one skilled in the art, one or more control aspects of the present invention may be embodied as a system, method or computer program product. Accordingly, one or more control aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, one or more control aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

In one example, a computer program product includes, for instance, one or more non-transitory computer readable storage media to store computer readable program code means or logic thereon to provide and facilitate one or more aspects of the present invention.

Program code embodied on a computer readable medium may be transmitted using an appropriate medium, including but not limited to, wireless, wireline, optical fiber cable, RF, etc., or any suitable combination of the foregoing.

Computer program code for carrying out operations for one or more aspects of the present invention may be written in any combination of one or more programming languages, including an object oriented programming language, such as Java, Smalltalk, C++ or the like, and conventional procedural programming languages, such as the “C” programming language, assembler or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

One or more control aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of one or more control aspects of the present invention. In this regard, each block in the flowchart or blocks diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In one aspect of the present invention, an application may be deployed for performing one or more control aspects of the present invention. As one example, the deploying of an application comprises providing computer infrastructure operable to perform one or more control aspects of the present invention.

As a further aspect of the present invention, a computing infrastructure may be deployed comprising integrating computer readable code into a computing system, in which the code in combination with the computing system is capable of performing one or more aspects of the present invention.

As yet a further aspect of the present invention, a process for integrating computing infrastructure comprising integrating computer readable code into a computer system may be provided. The computer system comprises a computer readable medium, in which the computer medium comprises one or more aspects of the present invention. The code in combination with the computer system is capable of performing one or more control aspects of the present invention.

Although various embodiments are described above, these are only examples. Further, other types of computing environments can benefit from one or more aspects of the present invention.

As a further example, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

Additionally, the term “coupled”, as used herein, means connected, although not necessarily directly, and not necessarily mechanically. The term “substantially” and its variations are defined as being largely, but not necessarily wholly, what is specified as understood by one of ordinary skill in the art, and in one non-limiting embodiment, “substantially” refers to ranges within 10%, such as within 5%, or more particularly, within 1% of what is specified.

Further, the fluid employed in the acoustic wave systems described herein above may be water, such as de-ionized, distilled or otherwise purified water, or may comprise a chemical solution. The chemical solution may be selected, for example, based on the ease of removal of the solution from the target surface after the cleaning processes is complete. In one embodiment, the cleaning solution may include cleaning particles suspended in a suspending medium, such as an aqueous solution or gas. Alternatively, or in addition to, the cleaning solution may includes a surfactant (e.g., non-ionic surfactant and/or a silicone-based surfactant). Alternatively, the cleaning solution may be a slurry. The slurry may include, without limitation, cleaning particles (e.g., silica, silicon nitride, and the like, and a basic solution to prevent the cleaning solution from combining.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

What is claimed is:

1. A system comprising:
an acoustic wave generator, the acoustic wave generator generating acoustic waves; and
at least one acoustic coupler associated with the acoustic wave generator and coupling the acoustic waves generated by the acoustic wave generator into a fluid, the at least one acoustic coupler comprising at least one acoustic coupling lens directing the acoustic waves into the fluid and facilitating, at least in part, a streaming flow of the fluid in a common direction.

2. The system of claim 1, wherein the common direction of the streaming fluid flow is at an angle to a direction acoustic waves are generated by the acoustic wave generator, and wherein the at least one acoustic coupling lens, in directing the acoustic waves into the fluid, redirects the acoustic waves from the direction of acoustic wave generation.

3. The system of claim 2, wherein the common direction of the streaming fluid flow is substantially perpendicular to the direction acoustic waves are generated by the acoustic wave generator.

4. The system of claim 1, wherein one acoustic coupler of the at least one acoustic coupler comprises a plurality of acoustic coupling lenses directing acoustic waves into the fluid and facilitating, at least in part, the streaming flow of fluid in the common direction.

5. The system of claim 4, wherein multiple acoustic coupling lenses of the plurality of acoustic coupling lenses are each an angled acoustic coupling lens or a focusing acoustic coupling lens, the multiple acoustic coupling lenses redirecting the acoustic waves with directing of the acoustic waves into the fluid to facilitate the streaming fluid flow in the common direction.

6. The system of claim 1, wherein the acoustic wave generator generates the acoustic waves with a frequency of 20 MHz or higher, and wherein the acoustic wave generator comprises a piezoelectric transducer.

7. The system of claim 1, wherein the at least one acoustic coupling lens directs the acoustic waves into the fluid, at least in part, towards a target surface and the acoustic waves reduce a boundary layer thickness of the fluid at the target surface, the common direction of the streaming fluid flow being substantially parallel to the target surface.

8. The system of claim 1, further comprising a nozzle structure, the acoustic wave generator and the at least one acoustic coupler, with the at least one acoustic coupling lens, being disposed within the nozzle structure.

9. The system of claim 8, wherein the nozzle structure comprises one or more channels through which the streaming fluid flows, and into which the at least one acoustic coupling lens of the at least one acoustic coupler extends and directs the acoustic waves.

10. The system of claim 8, wherein the nozzle structure comprises one of a circular-shaped transverse cross-section to the common direction, a rectangular-shaped transverse cross-section to the common direction, or a square-shaped transverse cross-section to the common direction.

11. The system of claim 8, wherein an outlet of the nozzle structure is disposed at an angle to a target surface and the nozzle structure directs the fluid, at least in part, towards the target surface, and wherein the system further comprises a flow coupler disposed at the outlet of the nozzle structure, the flow coupler acoustically pushing fluid egressing from the outlet of the nozzle structure towards the target surface and thereby further reducing a thickness of a boundary layer at the target surface.

12. The system of claim 11, wherein the flow coupler comprises an angled acoustic coupling lens, the angled acoustic coupling lens being a larger lens than the at least one acoustic coupling lens of the acoustic coupler within the nozzle structure, and the angled acoustic coupling lens directing acoustic waves propagating within the flow coupler into the fluid at the outlet of the nozzle structure and to force fluid egressing from the fluid outlet of the nozzle structure towards the target surface.

13. The system of claim 8, further comprising a fluid reservoir, the nozzle structure being coupled in fluid communication with the fluid reservoir, and wherein the acoustic waves directed into the fluid within the nozzle structure facilitate pumping fluid from the fluid reservoir through one or more channels of the nozzle structure through which the streaming fluid flows and into which the acoustic waves are directed by the at least one acoustic coupling lens of the at least one acoustic coupler.

14. A system comprising:
an acoustic wave generator, the acoustic wave generator generating acoustic waves;
at least one acoustic coupler associated with the acoustic wave generator and coupling the acoustic waves generated by the acoustic wave generator into a fluid, the at least one acoustic coupler comprising:
a plurality of acoustic coupling lenses directing acoustic waves into the fluid and facilitating, at least in part, a streaming flow of the fluid in a common direction; and
wherein the common direction of the streaming fluid flow is at an angle to a direction acoustic waves are generated by the acoustic wave generator, and the plurality of acoustic coupling lenses, redirect the acoustic waves from the direction of acoustic wave generation with directing of the acoustic waves into the fluid.

15. The system of claim 14, further comprising multiple acoustic couplers, wherein each acoustic coupler of the multiple acoustic couplers comprises a plurality of acoustic coupling lenses directing acoustic waves into the fluid and facilitating, at least in part, the streaming flow of fluid in the common direction.

16. The system of claim 15, wherein multiple acoustic coupling lenses of the plurality of acoustic coupling lenses of the multiple acoustic couplers are each an angled acoustic coupling lens or a focusing acoustic coupling lens, the multiple acoustic coupling lenses redirecting the acoustic waves with directing of the acoustic waves into the fluid.

17. The system of claim 14, wherein the acoustic wave generator generates acoustic waves with a frequency of 20 MHz or higher, and wherein the acoustic wave generator comprises a piezoelectric transducer.

18. The system of claim 14, further comprising a nozzle structure, the acoustic wave generator and the at least one acoustic coupler, with the plurality of acoustic coupling lenses, being disposed within the nozzle structure.

19. The system of claim 18, wherein the nozzle structure comprises one or more channels through which the streaming fluid flows, and into which the plurality of acoustic coupling lenses of the at least one flow coupler extend and direct the acoustic waves.

20. The system of claim 18, further comprising a fluid reservoir, the nozzle structure being coupled in fluid communication with the fluid reservoir, and wherein the acoustic waves directed into the fluid within the nozzle structure facilitate pumping fluid from the fluid reservoir through one or more channels of the nozzle structure through which the streaming fluid flows and into which the acoustic waves are directed by the plurality of acoustic coupling lenses of the at least one acoustic coupler.

21. The system of claim 14, wherein the plurality of acoustic coupling lenses direct the acoustic waves into the fluid, at least in part, towards a target surface, and thereby, reduce a boundary layer thickness of the fluid at the target surface, the common direction of the streaming fluid flow being substantially parallel to the target surface, and wherein the system further comprises a position regulator facilitating moving the at least one acoustic coupler and the target surface relative to each other.

22. A method comprising:
providing an acoustic wave generator, the acoustic wave generator generating acoustic waves; and
providing at least one acoustic coupler associated with the acoustic wave generator and coupling the acoustic waves generated by the acoustic wave generator into a fluid, the at least one acoustic coupler comprising at least one acoustic coupling lens directing the acoustic waves into the fluid and facilitating, at least in part, a streaming flow of the fluid in a common direction.

23. The method of claim 22, wherein the common direction of the streaming fluid flow is at an angle to a direction acoustic waves are generated by the acoustic wave generator, and the at least one acoustic coupling lens, in directing the acoustic waves into the fluid, redirects the acoustic waves from the direction of acoustic wave generation.

24. The method of claim 22, further comprising providing a nozzle structure, wherein the acoustic wave generator and the at least one acoustic coupler, with the at least one acoustic coupling lens, are disposed within the nozzle structure, and the nozzle structure comprises one or more channels through which the streaming fluid flows, and into which the at least one acoustic coupling lens of the at least one acoustic coupler extends and directs the acoustic waves.
